(19) United States
(12) Patent Application Publication
(10) Pub. No.: US 2018/0302188 A1
(43) Pub. Date: Oct. 18, 2018

(54) SYSTEM AND METHOD FOR SIMULTANEOUS TRANSMISSION OF THE SAME RADIO SIGNAL PACKET FROM MULTIPLE ANCHOR NODES

(71) Applicant: CIHOLAS INC, NEWBURGH, IN (US)

(72) Inventors: MIKE E. CIHOLAS, EVANSVILLE, IN (US); JUSTIN E. BENNETT, NEWBURGH, IN (US); JEREMY W. ALDRIDGE, EVANSVILLE, IN (US); TIM M. DEBAILLIE, EVANSVILLE, IN (US)

(73) Assignee: CIHOLAS INC, NEWBURGH, IN (US)

(21) Appl. No.: 15/955,404

(22) Filed: Apr. 17, 2018

Related U.S. Application Data
(60) Provisional application No. 62/602,210, filed on Apr. 17, 2017.

(51) Int. Cl. H04L 1/06; H04B 7/06; H04L 12/833

(52) U.S. Cl. CPC H04L 1/0625; H04L 47/31; H04B 7/0669

(57) ABSTRACT

A system and method whereby a group of synchronized anchor nodes transmit the identical radio signal packet at a specified time or specified times, which multiple signal packets are received at one or more tag/receiving nodes located within the area of use is provided. First, the time of each of the plurality of anchor nodes is synchronized relative to the other anchor nodes. A transmit time is then specified for each of the anchor nodes to transmit the identical data packet of information from each individual anchor node. The identical data packet of information and specified transmit time are then provided to each of the anchor nodes. The identical data packet of information is then transmitted from each anchor node into the area of use, wherein each of the identical data packets are transmitted from each respective one of the plurality of anchor nodes at the transmit time specified for that anchor node. The plurality of identical data packets of information are then received at the tag node from a plurality of the anchor nodes.

### BACKGROUND OF THE INVENTION

### Field of the Invention

The present invention relates to a system and method for synchronized network communications from a plurality of anchor nodes in multiple locations to one or more tag nodes in an area of use. More specifically, the present invention relates to a system and method whereby a group of synchronized anchor nodes transmit the identical radio signal packet at a specified time or specified times, said multiple signal packets are received at one or more tag/receiving nodes located within the area of use.

### Description of the Related Art

A typical ultra-wide band (UWB) radio system used for monitoring tag nodes within an area of use has a number of anchor nodes, typically in fixed, known locations spread over the area of use. The tag nodes are typically mobile, although stationary tag nodes in the area of use are also contemplated. The UWB radio system can exchange radio packets which contain digital information encoded in the UWB signal. These tag nodes are often designed to be small in size, and, as such, the antennas on the tag nodes can be of limited capability when it comes to receiving radio signals. This effectively limits the tag's reception range. Also, often times there are a large number of tag nodes located within the area of use. In some cases, it is desirable to be able to send the same message to all tag nodes at the same time.

Accordingly, there is a need for a system and method that extends the currently limited radio range and reliability of a typical UWB radio system with multiple anchor/transmitting nodes. There is also a need for a system and method for simultaneously sending the same radio signal packet to all or a large number of tag nodes spread throughout a larger area of use.

### SUMMARY OF THE INVENTION

An object of the present invention is to provide a system and method that extends the currently limited radio range and reliability of a typical UWB radio system with multiple anchor/transmitting nodes.

Another object of the invention is to provide a system and method for simultaneously sending multiple copies of the same radio signal packet to all or a large number of tag nodes spread throughout a larger area of use.

The present invention meets these objects by providing a system and method whereby a group of synchronized anchor nodes transmit the identical radio signal packet at a specified time or specified times, which multiple signal packets are received at one or more tag/receiving nodes located within the area of use.

According to one presently preferred embodiment of the invention, there is provided a method for transmitting a data packet of information from each of a plurality of anchor nodes to a tag node in an area of use. Each anchor nodes includes a radio transmitter, the tag node includes a radio receiver, and the data packet of information from each of the plurality of anchor nodes are identical. First, the time of each of the plurality of anchor nodes is synchronized relative to the other anchor nodes. A transmit time is then specified for each of the anchor nodes to transmit the identical data packet of information from each individual anchor node. The identical data packet of information and specified transmit time are then provided to each of the anchor nodes. The identical data packet of information is then transmitted from each anchor node into the area of use, wherein each of the identical data packets are transmitted from each respective one of the plurality of anchor nodes at the transmit time specified for that anchor node. The plurality of identical data packets of information are then received at the tag node from a plurality of the anchor nodes.

The step of providing the identical data packet of information and specified transmit time to each of the anchor nodes may further comprise transmitting the identical data packets of information and specified transmit times from a computer to each of the anchor nodes. In addition, the radio receiver in the tag node may be capable of handling multipath radio signals. According to a further aspect of the invention, the radio transmitter in each anchor node and the radio receiver in the tag node are ultra wide band radio transceivers. A plurality of tag nodes may also be provided.

According to one implementation of the method of the invention, the transmit time specified for each of the plurality of anchor nodes is substantially the same. In this implementation, the step of transmitting the identical data packet of information from each anchor node into the area of use is performed at substantially the same time for each anchor node.

According to an alternative implementation of the method of the invention, the location of the tag node is known and the transmit time specified for each of the plurality of anchor nodes is dependent upon the distance between the anchor node and the tag node. In this implementation, the step of transmitting the identical data packet of information from each anchor node into the area of use is performed at a different time for each anchor node depending on the distance between the anchor node and the tag node, and the step of receiving a plurality of identical data packets of information at the tag node comprises receiving the identical data packets of information from each anchor node at substantially the same time.

According to a further aspect of the invention a system for transmitting a plurality of identical data packets of information in an area of use is provided. The system includes a plurality of anchor nodes, each of the anchor nodes having a radio transmitter; a tag node which includes a radio receiver; means for synchronizing the time of each of the plurality of anchor nodes relative to the other anchor nodes; means for specifying a transmit time for each of the anchor nodes to transmit the identical data packet of information from each individual anchor node; means for providing the identical data packet of information and specified transmit time to each of the anchor nodes; means for transmitting the plurality of identical data packets from each anchor node into the area of use at the transmit time specified for that anchor node; and means for receiving the plurality of identical data packets at the tag node.

According to this aspect of the invention, the means for providing the identical data packet of information and specified transmit time to each of said anchor nodes may comprise a computer in communication with the plurality of anchor nodes, and/or the means for specifying a transmit time for each of the anchor nodes to transmit the identical data packet of information from each individual anchor node may comprise a computer in communication with the plurality of anchor nodes.

The radio receiver in the tag node of the system for transmitting a plurality of identical data packets of information in an area of use may be capable of handling multipath radio signals. The radio transmitters in the anchor nodes and the radio receivers in the tag node may be ultra wide band radio transceivers. A plurality of tag nodes may also be provided in the area of use.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a schematic diagram of a system for locating an asset in an area of use according to a presently preferred embodiment of the invention, which system utilizes the method of the present invention.

FIG. 2 is schematic diagram showing a plurality of anchor nodes varying distances from a tag node according to one aspect of the present invention.

FIG. 3A is a timing diagram depicting transmission and reception times where the plurality of anchors transmit at substantially the same time according to a preferred embodiment of the invention.

FIG. 3B is a timing diagram depicting transmission and reception times where the plurality of anchors transmit different times so that the signals are received at an identified tag node at substantially the same time according to an alternative embodiment of the invention.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

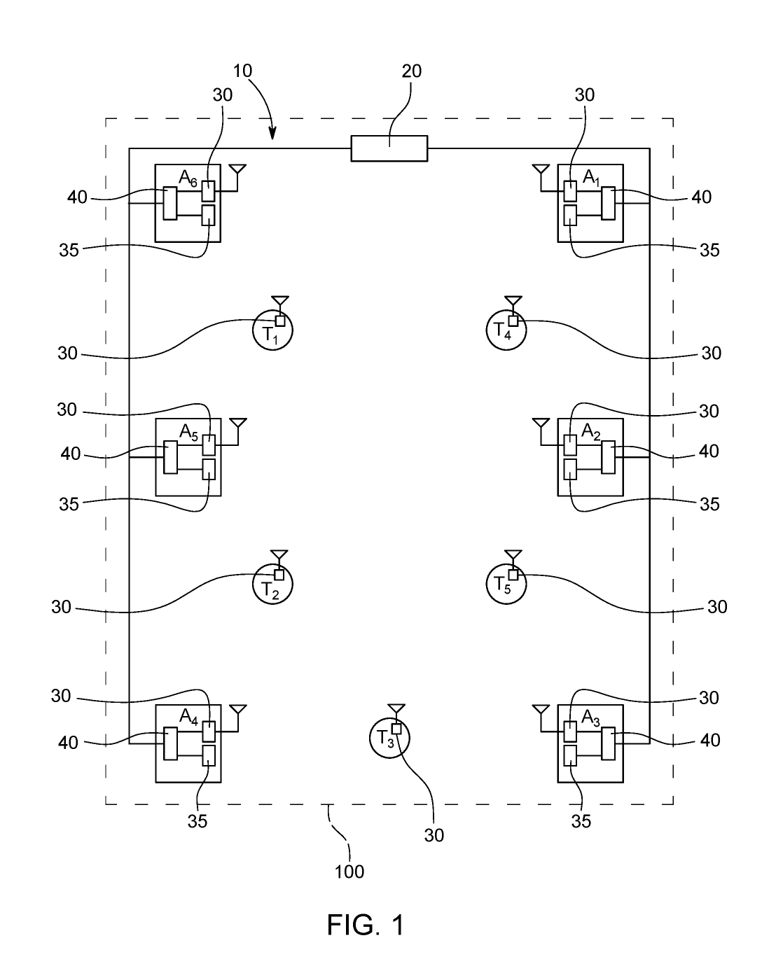

As best shown in FIG. 1, one presently preferred embodiment of the invention is a UWB radio system 10 having a plurality of anchor/transmitting nodes A1, A2, A3, A4, A5, A6 in fixed locations spread over the area of use 100. A plurality of tag/receiving nodes T1, T2, T3, T4, T5 are provided within the area of use 100 and are typically mobile. The anchor nodes A1, A2, A3, A4, A5, A6 according to a preferred embodiment of the invention, may be controlled by a central resource such as a computer server 20. The computer server 20 coordinates the operation of the anchor nodes A1, A2, A3, A4, A5, A6 and tag nodes T1, T2, T3, T4, T5, each of which may preferably include an UWB transceiver 30, such as the DecaWave DW1000. However, since the communication between anchors nodes and tag nodes according to the present invention is one-way, it is only necessary to provide a transmitter in association with each anchor node an a receiver in association with each tag node.

The control of the anchor nodes A1, A2, A3, A4, A5, A6 by the computer server 20 can be done through wired means of communication such as is shown in FIG. 1, or by wireless means of communication (not shown). Also, while FIG. 1 depicts six (6) anchor nodes and five (5) tag nodes, the system and method can function with as few as two (2) anchor nodes and a single tag node. By adding additional anchor nodes, the system can cover a larger area of use, and by adding additional tag nodes, additional assets can be communicated with within that area of use.

First, each anchor node A1, A2, A3, A4, A5, A6 includes a clock 35 that must be synchronized in time within reasonable tolerance, preferably to within 50-100 picoseconds, using one or more precise synchronization methods as are known in the prior art. The clock 35 may be connected directly or through a processor or controller 40 provided on the anchor node. The goal is for each one of the anchor nodes A1, A2, A3, A4, A5, A6 to have the same time within the accepted level of tolerance. Generally, such synchronization can be accomplished in many ways including, but not limited to either (1) connecting the clock 35 of each anchor node A1, A2, A3, A4, A5, A6 to a central clock (not shown) via wires of known length; (2) wirelessly linking the clock 35 of each anchor node A1, A2, A3, A4, A5, A6 to an accurate external clock source (i.e. GPS), or (3) by exchange of timing information between the clock 35 of each anchor node A1, A2, A3, A4, A5, A6 and mathematically modeling each anchor's clock to a common time.

For a network wherein the clock 35 of each anchor node A1, A2, A3, A4, A5, A6 is connected to a central time clock via wires, if the length of each wire connecting the central time clock to the time clock 35 of each anchor node A1, A2, A3, A4, A5, A6 is precisely known, one can account for the propagation delay across the wires and from that data synchronize the anchors.

Because the anchor nodes A1, A2, A3, A4, A5, A6 are fixed in known locations, the clock 35 of each can be synchronized wirelessly via external radio signals. The external radio signals may be terrestrially based (i.e. television signals) or satellite based (i.e. Global Navigation Satellite System (GNSS) or Global Positioning System (GPS)). The source of the external radio signal (i.e. GPS satellite) has it's own accurate time clock such as an atomic clock, which can then be synchronized with the clock 35 of each anchor node A1, A2, A3, A4, A5, A6 whose position is known relative to the GPS satellite or terrestrial transmitter.

Another method that can be utilized to synchronize the anchor nodes A1, A2, A3, A4, A5, A6 is by each anchor node A1, A2, A3, A4, A5, A6 exchanging UWB timing packets with other anchor nodes. The server, or computer 20 then takes the timing data from the exchange of these packets, and mathematically models each anchor's clock to a common time. Mathematical adjustments are made for each node and precise timing information is then transmitted from the computer 20 to each anchor node A1, A2, A3, A4, A5, A6, resulting in synchronization, preferably within 50-100 picoseconds.

Once the timing of the anchor nodes A1, A2, A3, A4, A5, A6 has been synchronized, the computer server 20 provides each anchor nodes A1, A2, A3, A4, A5, A6 with a packet to be sent and instructions on the specified time to send it. The packet contents are identical for all anchor nodes A1, A2, A3, A4, A5, A6. At the specified time, or within a small time window around it, which may be dependent upon the parameters of the chipset used, each anchor node A1, A2, A3, A4, A5, A6 transmits the exact same packet over the UWB radio system 10 on that anchor.

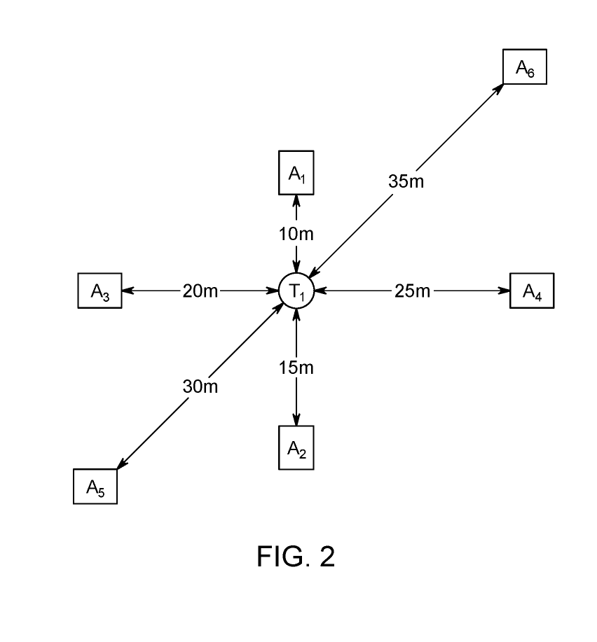

Each anchor finds the closest time it can transmit to the time specified by the computer server 20 so that all packets will transmit within the predetermined jitter window based on the parameters of the chipset. Each tag will be a variable distance from each anchor depending on its location. As shown in FIG. 2, assume tag node T1 is 10 meters from anchor node A1, 15 meters from anchor node A2, 20 meters from anchor node A3, 25 meters from anchor node A4, 30 meters from anchor node A5, and 35 meters from anchor node A6. The variation in distance from each anchor introduces about 17 nanoseconds of delay for each five meters of distance increase. Thus, the distance variation introduces a spread of packet receive times of about 85 nanoseconds. Total receive jitter is thus the specified jitter tolerance for the chipset used (eight nanoseconds for the presently preferred Decawave DW1000 chip) and 85 nanoseconds from distance variation to anchors for a total of 93 nanoseconds.

One or more of the tag nodes T1, T2, T3, T4, T5 may be listening during this time. At each tag node T1, T2, T3, T4, T5 the signals from the anchor nodes A1, A2, A3, A4, A5, A6 begin to arrive. The time of arrival (ToA) for each anchor, for example anchor node A1 will be the time it was transmitted Tₓ at that anchor node A1 plus the time of flight delay due to the distance between the anchor and the tag.

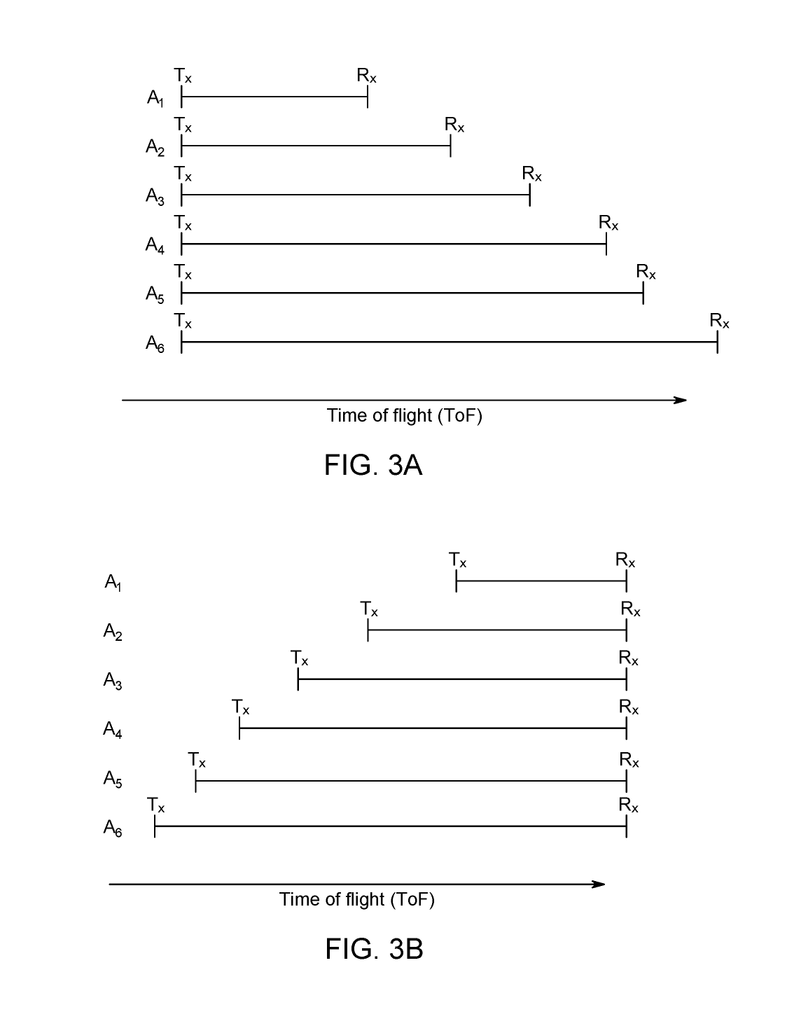

As shown in FIG. 3A, according to one implementation of the method of the invention, the transmit time Tₓ specified for each of the plurality of anchor nodes A1, A2, A3, A4, A5, A6 is substantially the same. In this implementation, the step of transmitting the identical data packet of information from each anchor node A1, A2, A3, A4, A5, A6 into the area of use 100 is performed at substantially the same time. Because the reception time Rₓ at the tag node T1 for each signal transmitted from each anchor depends on the anchor's proximity to the tag, the closer signals (i.e. anchor A1) will arrive sooner when all anchors transmit at substantially the same time.

As shown in FIG. 3B, according to an alternative implementation of the method of the invention, the location of the tag node T1 is known and the transmit time Tₓ specified for each of the plurality of anchor nodes A1, A2, A3, A4, A5, A6 is dependent upon the distance between the anchor node and the tag node T1. In this implementation, the step of transmitting the identical data packet of information from each anchor node A1, A2, A3, A4, A5, A6 into the area of use 100 is performed at a different time for each anchor node depending on the distance between the anchor node and the tag node T1. Further, the step of receiving a plurality of identical data packets of information at the tag node comprises receiving the identical data packets of information from each anchor node at substantially the same time Rₓ. Because the distance from each anchor to the tag T1 is known, the time of flight can be calculated, and from that, the transmission time adjusted for each anchor so that the signals arrive at substantially the same time.

With multiple anchor nodes transmitting at the same time within a small window of tolerance, the antennas on the tag nodes T1, T2, T3, T4, T5 will receive multiple overlaid copies of the same packet. The receiving circuits within each tag node are adept at handling multipath radio signals, meaning that receiving a transmission that contains not only the first path radio signal, but also delayed and amplitude modified versions of that signal caused by reflections from objects. Because each tag node, for example T1 is receiving identical signals from each anchor node A1, A2, A3, A4, A5, A6 at different times based on its proximity to that particular anchor node, the multitude of signals from multiple anchor nodes appear to the tag node T1 like multipath.

Because a particular tag node, i.e. tag node T1 is receiving energy of the radio signal from multiple anchor nodes, the received energy of the radio signal at the tag T1 is increased, potentially allowing the tag to receive the packet even if the radio signal from any single anchor would not have been sufficiently strong to transmit the packet to the tag. This enhances the tag's ability to receive packets with a small antenna and allows the tag to be smaller and still perform well.

One characteristic of the system is that the packet from an anchor node, e.g. A6, which is closer to a tag node, e.g. T1 will reach the tag sooner. The tag receiver circuits tend to favor the earlier signals and thus will come to ignore the weaker more distant signals—e.g. the signal from anchor A3 at tag T1 in FIG. 1. This characteristic allows building a very large network in which all anchor nodes transmit at the same time, but where the tag nodes tend to hear generally only the closer set of anchors, meaning that the network of anchors does not have to be split into zones that transmit in a way to avoid collision.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

We claim:

1. A method for transmitting a data packet of information from each of a plurality of anchor nodes to a tag node in an area of use, each of said anchor nodes having a radio transmitter, said tag node having a radio receiver, and the data packet of information from each of the plurality of anchor nodes being identical, said method comprising the steps of:
synchronizing the time of each of the plurality of anchor nodes relative to the other anchor nodes;
specifying a transmit time for each of the anchor nodes to transmit the identical data packet of information from each individual anchor node;
providing the identical data packet of information and specified transmit time to each of said anchor nodes;
transmitting the identical data packet of information from each anchor node into the area of use, wherein each of the identical data packets are transmitted from each respective one of the plurality of anchor nodes at the transmit time specified for that anchor node; and
receiving a plurality of the identical data packets of information at the tag node from a plurality of the anchor nodes.

2. The method for transmitting a data packet of information according to claim 1, wherein the step of providing the identical data packet of information and specified transmit time to each of said anchor nodes comprises transmitting the identical data packets of information and specified transmit times from a computer to each of said anchor nodes.

3. The method for transmitting a data packet of information according to claim 1, wherein the radio receiver in the tag node is capable of handling multipath radio signals.

4. The method for transmitting a data packet of information according to claim 1, wherein the radio transmitter in each anchor node and the radio receiver in the tag node are ultra wide band radio transceivers.

5. The method for transmitting a data packet of information according to claim 1, wherein a plurality of tag nodes are provided.

6. The method for transmitting a data packet of information according to claim 1, wherein the transmit time specified for each of the plurality of anchor nodes is substantially the same, such that the step of transmitting the identical data packet of information from each anchor node into the area of use is performed at substantially the same time for each anchor node.

7. The method for transmitting a data packet of information according to claim 1, wherein the location of the tag node is known and the transmit time specified for each of the plurality of anchor nodes is dependent upon the distance between the anchor node and the tag node, such that the step of transmitting the identical data packet of information from each anchor node into the area of use is performed at a different time for each anchor node depending on the distance between the anchor node and the tag node.

8. The method for transmitting a data packet of information according to claim 7, wherein the step of receiving a plurality of identical data packets of information at the tag node comprises receiving the identical data packets of information from each anchor node at substantially the same time.

9. A system for transmitting a plurality of identical data packets of information in an area of use comprising:
a plurality of anchor nodes, each of said anchor nodes having a radio transmitter;
a tag node which includes a radio receiver;
means for synchronizing the time of each of the plurality of anchor nodes relative to the other anchor nodes;
means for specifying a transmit time for each of the anchor nodes to transmit said identical data packet of information from each individual anchor node;
means for providing the identical data packet of information and specified transmit time to each of said anchor nodes;
means for transmitting said plurality of identical data packets from each anchor node into the area of use at the transmit time specified for that anchor node; and
means for receiving said plurality of identical data packets at the tag node.

10. The system for transmitting a plurality of identical data packets of information in an area of use according to claim 9, wherein the means for providing the identical data packet of information and specified transmit time to each of said anchor nodes comprises a computer in communication with said plurality of anchor nodes.

11. The system for transmitting a plurality of identical data packets of information in an area of use according to claim 10, wherein the means for specifying a transmit time for each of the anchor nodes to transmit said identical data packet of information from each individual anchor node comprises a computer in communication with said plurality of anchor nodes.

12. The system for transmitting a plurality of identical data packets of information in an area of use according to claim 9, wherein the means for specifying a transmit time for each of the anchor nodes to transmit said identical data packet of information from each individual anchor node comprises a computer in communication with said plurality of anchor nodes.

13. The system for transmitting a plurality of identical data packets of information in an area of use according to claim 9, wherein the radio receiver in the tag node is capable of handling multipath radio signals.

14. The system for transmitting a plurality of identical data packets of information in an area of use according to claim 9, wherein the radio transmitters in the anchor nodes and the radio receivers in the tag node are ultra wide band radio transceivers.

15. The system for transmitting a plurality of identical data packets of information in an area of use according to claim 9, wherein a plurality of tag nodes are provided.
